(19) United States
(12) Patent Application Publication
(10) Pub. No.: US 2014/0121230 A1
(43) Pub. Date: May 1, 2014

(54) TOPICAL PARASITICIDAL FORMULATION

(71) Applicant: Emmanuel Gonzales De Asis, Crows Nest (AU)

(72) Inventor: Emmanuel Gonzales De Asis, Crows Nest (AU)

(21) Appl. No.: 14/065,816

(22) Filed: Oct. 29, 2013

(30) Foreign Application Priority Data
Nov. 1, 2012 (AU) 2012904792
Nov. 20, 2012 (EP) 12193358.4

(51) Int. Cl. A01N 43/54

(52) U.S. Cl. CPC A01N 43/54
USPC 514/275

(57) ABSTRACT

The present invention relates to topical parasiticidal formulations comprising a parasiticide, an organo-silicone surfactant and a topically acceptable liquid carrier, and methods of preventing or treating parasites on an animal.

### CROSS-REFERENCE TO RELATED APPLICATIONS

This application is a non-provisional application that claims priority under 35 U.S.C. §119(a) of Australian Patent Application No. 2012904792, filed Nov. 1, 2012, the contents of which are hereby incorporated by reference in its entirety.

### FIELD OF THE INVENTION

The present invention relates to a formulation for controlling parasites on an animal, and to methods of preventing or treating infestations of parasites on an animal.

### BACKGROUND ART

Sheep and other domesticated livestock are subject to infestation by a wide range of ectoparasites such as lice, blow-fly larvae, ticks, head flies, keds and sheep scab. Fly strike (myiasis) in sheep is a significant problem causing significant suffering to the animal and loss of production in infected livestock. At certain times of the year when blow flies are active, the adult blow fly lays eggs on the sheep. When these eggs hatch, the fly enters a series of larval stages and, during some of these stages, the larvae feed on the flesh of the infected sheep. This is known as fly strike or myiasis. Fly strike is caused by a number of species of blow fly, including Lucilia cuprina, L. sericata, Chrysomia rufifacies, and Calliphora stygia.

Traditionally infestations of ectoparasites on animals have been prevented or treated by applying a parasiticide to the entire body of the animal by either dipping the whole animal in a bath containing the parasiticide or by spraying a formulation containing the parasiticide over the entire body surface of the animal. More recently, certain formulations of some parasiticides have been developed that can be applied by localised application (so-called “pour-on” or “spray-on” application) to prevent or control ectoparasites on an animal. By “localised application” it is meant that the formulation is only applied to a minor portion of the outer surface of the animal, for example, as a line or spot on the animal's back. External parasites on an animal are typically more prevalent at the rear, crutch or underside of the animal. In order for formulations applied by localised application to be able to control ectoparasites over the entire body of the animal, the active ingredient must be able to spread over the entire body of the animal. For example, pour-on formulations are typically applied to the back of an animal, while the parasites infesting the animal are usually located at the rear, crutch or underside of the animal.

A wide variety of parasiticides have been used to treat and/or prevent various ectoparasites on livestock. For example, agents that act to kill parasites on contact with, or ingestion by, the parasite have been used to treat and/or prevent fly strike on sheep. Another class of parasiticides effective to treat and/or prevent ectoparasite infestations are the insect growth regulators (IGRs). IGRs disrupt the growth cycle of insects.

A variety of IGRs have been described in the published literature, including 4,6-diamino-2-(cyclopropylamino)-5-pyrimidinecarbonitrile (dicyclanil). Several different formulations containing dicyclanil for application by a variety of different means are commercially available. These different types of formulation include non-aqueous and aqueous formulations.

In view of the significant problem of parasite infestation of animals, there is a continuing need to develop and improve formulations for preventing and treating parasite infestations.

### DISCLOSURE OF THE INVENTION

In a first aspect, the present invention provides a formulation for topical application to an animal, the formulation comprising a parasiticide, about 20 g/L or more of organo-silicone surfactant, and a topically acceptable liquid carrier.

In a second aspect, the present invention provides a method of preventing or treating ectoparasites on an animal, the method comprising topically applying to the animal an effective amount of a formulation according to the first aspect of the present invention.

In a third aspect, the present invention provides use of a formulation according to the first aspect of the present invention in the manufacture of a medicament for the prevention or treatment of an infestation of ectoparasites on an animal.

In a fourth aspect, the present invention provides a formulation comprising a parasiticide, about 20 g/L or more of organo-silicone surfactant, and a topically acceptable liquid carrier, for use in the prevention or treatment of an infestation of ectoparasites on an animal.

In a fifth aspect, the present invention provides a formulation for topical application to an animal, the formulation comprising 20 to 60 g/L of a parasiticide, 20 to 200 g/L of organo-silicone surfactant, and water.

### DETAILED DESCRIPTION OF THE INVENTION

In a first aspect, the present invention provides a formulation for topical application to an animal, comprising a parasiticide, about 20 g/L or more of organo-silicone surfactant, and a topically acceptable liquid carrier.

The inventor of the present invention has surprisingly found that the inclusion of one or more organo-silicone surfactants in an amount of about 20 g/L or more in a topical formulation comprising a parasiticide and a liquid carrier, provides a formulation that has greater spreading, wetting and infiltration (i.e. penetration into wool or fleece) capacity than similar formulations containing other surfactants or not containing a surfactant. The spreading, wetting and infiltration properties of the formulation allow the parasiticide to readily spread over the entire body of an animal to control ectoparasites over the entire body of the animal.

Further, when the formulation is applied to the wool or fleece of an animal, the wetting, spreading and infiltration properties of the formulation promote rapid uptake of the formulation, and therefore the parasiticide, into the wool or fleece of the animal. The rapid uptake of the parasiticide improves the rain fastness of the formulation, i.e. reduces the amount of the parasiticide washed off the animal in the event that the animal is exposed to rain shortly after the formulation has been topically applied to the animal.

Typically, the formulation is an aqueous formulation. The topically acceptable liquid carrier is therefore typically an aqueous carrier. Typically, the formulation comprises about 300 g/L or more, more typically about 500 g/L or more, of water. Aqueous formulations are preferable as such formulations are generally easier and safer to handle than formulations comprising a large proportion of an organic solvent.

The parasiticide may be any agent that is capable of controlling, preventing or treating an infestation of ectoparasites on an animal (an agent capable of controlling, preventing or treating an infestation of ectoparasites on an animal is sometimes referred to as an “ectoparasiticide”). The parasiticide may, for example, be an avermectin (such as abamectin); a synthetic pyrethroid (such as deltamethrin and cypermethrin); an organophosphate (such as diazinon and temephos); an imidazothiole (such as levamisole); a salicylanilide (such as oxyclozanide); a benzimidazole (such as oxfendazole); an amidine (such as amitraz); or an insect growth regulator.

The insect growth regulator may, for example, be selected from the group consisting of dicyclanil, diflubenzuron, triflumuron, fluazuron, methoprene and combinations thereof. In some embodiments, the parasiticide is dicyclanil.

When the formulation is to be used for the prevention or treatment of myiasis, the parasiticide is preferably an insect growth regulator. Formulations of the present invention comprising an insect growth regulator, for example dicyclanil, can provide continuing protection against fly strike for an extended period, e.g. up to 14 weeks.

The formulation may be provided as a concentrate intended to be diluted prior to application to an animal, or may be provided as a ready-to-use formulation. The formulation when applied to the animal typically contains an effective amount of the parasiticide such that a convenient volume of the formulation is required to provide an effective dose of the parasiticide to prevent or treat an infestation of ectoparasites on the animal. A convenient volume of a formulation intended for localised topical application, e.g. in a line or lines on the back of the animal, is generally less than about 3 mL per kg body weight. A person skilled in the art could readily determine suitable concentrations of the parasiticide based on the amount of the parasiticide required to provide an effective dose and the volume of the formulation to be topically applied to the animal.

In some embodiments, the formulation of the present invention comprises from about 20 g/L to about 60 g/L of the parasiticide.

When the parasiticide is dicyclanil, the formulation of the present invention may, for example, comprise dicyclanil at a concentration of from about 20 g/L to about 60 g/L.

For example, the formulation may comprise dicyclanil in a concentration of from about 30 g/L to about 60 g/L, e.g. from about 20 g/L to about 50 g/L, from about 33 g/L to about 55 g/L, or from about 33 g/L to about 50 g/L.

The formulation of the present invention comprises about 20 g/L or more of organo-silicone surfactant. By “about 20 g/L or more of organo-silicone surfactant” it is meant that the formulation comprises at least about 20 g/L of one or more organo-silicone surfactants. For example, the formulation may comprise the one or more organo-silicone surfactants in an amount of about 20 g/L to about 200 g/L, e.g. about 20 g/L to about 170 g/L, about 50 g/L to about 200 g/L, about 50 g/L to about 170 g/L, about 70 g/L to about 150 g/L or about 80 g/L to about 120 g/L.

As used herein, the term “organo-silicone surfactant” refers to any surface active compound comprising at least one Si—C bond. Preferably, the “organo-silicone surfactant” comprises a siloxane group, i.e. a O—Si—C group.

Examples of commercially available organo-silicone surfactants are listed in Table 1. Some of the products listed in Table 1 comprise an organo-silicone surfactant in a mixture with one or more other agents, such as an oil or another surfactant. The products listed in Table 1 may be included in the formulation of the present invention to provide the 20 g/L or more of organo-silicone surfactant.

TABLE 1

| | | | PRINCIPAL |
|---|---|---|---|
| PRODUCT | MANUFACTURER/ | ADJUVANT | FUNCTIONING |
| NAME | DISTRIBUTOR | CATEGORY | AGENTS |
| ACTION 99 | UCPA LLC | Organo-Silicone | Nonionic organosilicone |
| | | Surfactant | wetting agent |
| BREAK-THRU | Plant Health | Organo-Silicone | Polyether- |
| | Technologies | Surfactant | polymethylsiloxane- |
| | | | copolymer |
| CADENCE | KALO, Inc. | Organo-Silicone | Polyether- |
| | | Surfactant | polymethylsiloxane- |
| | | and | copolymer and nonionic |
| | | Nonionic | surfactant |
| | | Surfactant | |
| CHEMPRO S- | Chemorse, Ltd. | Organo-Silicone | Alkylphenol ethoxylate, |
| 163 | | Surfactant | polyether-modified |
| | | | polysiloxane, and glycol |
| | | | blend |
| CHEMPRO S- | Chemorse, Ltd. | Methylated or | Proprietary blend of |
| 172 | | Ethylated | polyalkyleneoxide |
| | | Vegetable Oil | modified |
| | | and | polydimethylsiloxane, |
| | | Organo-Silicone | nonionic emulsifiers and |
| | | Surfactant | methylated seed oil |
| DRENCH | Garrco Products, | Organo-Silicone | Siloxane surfactant |
| | Inc. | Surfactant | |
| DYNE-AMIC | Helena Chemical | Methylated or | Proprietary blend of |
| | Co. | Ethylated | polyethoxlated dimethyl |
| | | Vegetable Oil | siloxanes, alkylaryl |
| | | and | ethoxylates and |
| | | Organo-Silicone | methylated seed oils |
| | | Surfactant | |
| | | and | |
| | | Nonionic | |
| | | Surfactant | |
| EXCEL 2000 | Coastal | Organo-Silicone | Polyether |
| | Agrobusiness, Inc. | Surfactant | polymethylsiloxane |
| | | | copolymer |
| FASTSTRIKE | J. R. Simplot | Methylated or | Proprietary blend of |
| | Company | Ethylated | polyalkyleneoxide |
| | | Vegetable Oil | modified |
| | | and | polydimethylsiloxane |
| | | Organo-Silicone | nonionic emulsifiers and |
| | | Surfactant | methylated vegetable oil |
| FIRST CHOICE | Evonik | Organo-Silicone | Polyether- |
| BREAK-THRU | Goldschmidt | Surfactant | polymethylsiloxane- |
| | Chemical | | copolymer |
| | Corporation | | |
| FREEWAY | Loveland Products, | Organo-Silicone | Silicone polyether co- |
| | Inc. | Surfactant | polymer and alcohol |
| | | | ethoxylates |
| GALACTIC | Custom | Organo-Silicone | Blend of modified |
| | Chemicides | Surfactant | polydimethylsiloxane and |
| | | and | nonionic surfactants |
| | | Nonionic | |
| | | Surfactant | |
| IMPACT | Jay-Mar, Inc. | Organo-Silicone | Proprietary blend of |
| | | Surfactant | polyalkyleneoxide, |
| | | | modified |
| | | | heptamethyltrisiloxane |
| | | | and nonionic surfactant |
| INERGY | Winfield Solutions, | Methylated or | Proprietary blend of |
| | LLC | Ethylated | modified vegetable oil, |
| | | Vegetable Oil | polyalkyleneoxide |
| | | and | modified |
| | | Organo-Silicone | dimethylpolysiloxane and |
| | | Surfactant | nonionic emulsifiers |
| KINETIC | Helena Chemical | Organo-Silicone | Proprietary blend of |
| | Co. | Surfactant | polyalkyleneoxide |
| | | | modified |
| | | | polydimethylsiloxane and |
| | | | polyoxpropylene- |
| | | | polyoxyethylene block |
| | | | copolymers |
| KINETIC HV | Helena Chemical | Organo-Silicone | Proprietary blend of |
| | Co. | Surfactant | polyalkyleneoxide |
| | | | modified |
| | | | polydimethylsiloxane and |
| | | | polyoxpropylene- |
| | | | polyoxyethylene block |
| | | | copolymers |
| MATRIXX | Coastal | Organo-Silicone | Polymethylsiloxane |
| | Agrobusiness, Inc. | Surfactant | copolymer and |
| | | | polyethoxy ethers |
| PEERLESS | Custom | Nonionic | Organosilicone |
| | Chemicides | Surfactant | surfactant, methylated |
| | | and | vegetable oil, poly fatty |
| | | Organo-Silicone | acid esters, |
| | | Surfactant | polyethoxylated esters, |
| | | and | ethoxylated alkylaryl |
| | | Vegetable Oil | phosphate esters and |
| | | Concentrate | nonionic/anionic |
| | | | surfactants |
| PHASE | Loveland Products, | Methylated or | Methylated seed oil plus |
| | Inc. | Ethylated | organosilicone surfactant |
| | | Vegetable Oil | |
| | | and | |
| | | Organo-Silicone | |
| | | Surfactant | |
| QUARK | J. R. Simplot | Nonionic | Polyalkylene modified |
| | Company | Surfactant | heptamethyltrisiloxane |
| | | and | and nonionic surfactants |
| | | Organo-Silicone | |
| | | Surfactant | |
| RAIN-FAST | Conklin Co., Inc. | Organo-Silicone | Polyether- |
| | | Surfactant | polymethylsiloxane- |
| | | | copolymer, organic |
| | | | surfactants and anti- |
| | | | foaming agent |
| RIVET | Winfield Solutions, | Methylated or | Methylated seed oil plus |
| | LLC | Ethylated | organosilicone surfactant |
| | | Vegetable Oil | |
| | | and | |
| | | Organo-Silicone | |
| | | Surfactant | |
| SIL ENERGY | Brewer | Organo-Silicone | Polyalkyleneoxide |
| | International | Surfactant | modified |
| | | | polydimethyisoloxane |
| | | | and nonionic surfactants |
| SIL-FACT | Drexel Chemical | Organo-Silicone | Blend of organosilicone |
| | Co. | Surfactant | surfactant and alcohol |
| | | | ethoxylates |
| SIL-MES 100 | Drexel Chemical | Organo-Silicone | Blend of organosilicone |
| | Co. | Surfactant | surfactant, methylated |
| | | and | seed oil, alcohol |
| | | Methylated or | ethoxylate and NIS |
| | | Ethylated | |
| | | Vegetable Oil | |
| SILICONE | Brandt | Organo-Silicone | Polyether- |
| SUPER | Consolidated, Inc. | Surfactant | polymethylpolysiloxane- |
| WETTER | | | copolymer, polyether |
| SILKIN | Winfield Solutions, | Organo-Silicone | Polyalkyleneoxide |
| | LLC | Surfactant | modified |
| | | | heptamethyltrisiloxane |
| | | | and nonionic surfactant |
| SILNET 200 | Brewer | Organo-Silicone | Polyalkyleneoxide |
| | International | Surfactant | modified |
| | | | polydimethyisloloxane |
| | | | and nonionic surfactants |
| SILWET L-77 | Helena Chemical | Organo-Silicone | Polyalkyleneoxide |
| | Co.; | Surfactant | modified |
| | GE Silicones | | heptamethylsiloxane |
| SPEED | Precision Labs, | Organo-Silicone | Proprietary blend of |
| | Inc. | Surfactant | polyether polydimethyl |
| | | | siloxane copolymers |
| SUN ENERGY | Brewer | Organo-Silicone | Blend of methylated |
| | International | Surfactant | vegetable oil, and |
| | | | organosilicone |
| | | | surfactants |
| SUR-PLUS | United Suppliers, | Organo-Silicone | Silicone-polyether |
| | Inc. | Surfactant | copolymer and NIS |
| SYL-TAC | Wilbur-Ellis | Methylated or | Organosilicone |
| | Company | Ethylated | surfactant and modified |
| | | Vegetable Oil | vegetable seed oil blend |
| | | and | |
| | | Organo-Silicone | |
| | | Surfactant | |
| SYLGARD 309 | Wilbur-Ellis | Organo-Silicone | Organosilicone |
| (also sold under | Company; | Surfactant | surfactant |
| the name | Dow Corning | | |
| XIAMETER | Australia Pty Ltd | | |
| OFX 309) | | | |
| THOROUGHBRED | Winfield Solutions, | Organo-Silicone | Propietary blend of |
| | LLC | Surfactant | polyalkyleneoxide |
| | | and | modified |
| | | Nonionic | polydimethylsiloxane and |
| | | Surfactant | nonionic surfactants |
| WIDESPREAD | Loveland Products, | Organo-Silicone | Polyether- |
| MAX | Inc. | Surfactant | polymethylsiloxane- |
| | | | copolymer, polyether |

In an embodiment, the formulation of the present invention comprises an organo-silicone surfactant selected from the group consisting of 2-[acetoxy(polyethyleneoxy)propyl]heptamethyltrisiloxane, polyalkylene modified heptamethyltrisiloxane, polydiorganosiloxanes and combinations thereof.

In some embodiments, the organo-silicone surfactant comprises a trisiloxane group. The organo-silicone surfactant may, for example, be a compound of formula (I):

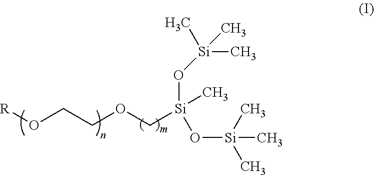

wherein R is selected from hydrogen, optionally substituted C₁-C₆-alkyl, optionally substituted C₂-C₆-alkenyl and optionally substituted C₂-C₇-acetyl;
n is an integer from 1 to 100; and
m is an integer from 1 to 10.

The term “alkyl” denotes a straight chain or branched alkyl. Examples of straight chain and branched alkyl include methyl, ethyl, propyl, isopropyl, butyl, isobutyl, sec-butyl, tert-butyl, pentyl, hexyl, 4-methylpentyl, and the like. The term “alkenyl” denotes groups formed from a straight chain or branched alkene containing one or more carbon to carbon double bonds. Examples of alkenyl include vinyl, allyl, 1-methylvinyl, butenyl, iso-butenyl, 3-methyl-2-butenyl, 1-pentenyl, and so forth. The term “C₂-C₇-acetyl” as used herein denotes a C₂-C₇-hydrocarbyl moiety having a carbonyl group at the first carbon from the point of attachment, i.e. a group of the formula R—C(O)—, wherein R is a C₁-C₆-alkyl, C₂-C₆-alkenyl or C₂-C₆-alkynyl group. Examples of C₂-C₇-acetyl include acetyl, isopropoyl, and the like.

The C₁-C₆-alkyl, C₂-C₆-alkenyl and C₂-C₇-acetyl may be optionally substituted with any substituent and any number of substituents provided the compound of formula (I) has surfactant activity. The substituent may, for example, be a halogen group, e.g. chloro, bromo or fluoro.

In an embodiment, the formulation comprises a surfactant of formula (I) wherein R is acetyl, n is an integer from 3 to 10, and m is 3.

In another embodiment, the formulation comprises a surfactant of formula (I) wherein R is methyl, n is an integer from 3 to 10, and m is 3.

Examples of organo-silicone surfactants comprising a trisiloxane group include 3-(3-hydroxypropyl)-heptamethyltrisiloxane, ethoxylated, acetate (i.e. 2-[acetoxy(polyethyleneoxy)propyl]heptamethyltrisiloxane) and polyalkylene modified heptamethyltrisiloxane. These surfactants are available commercially under the trade names Sylgard 309 (Dow Corning Australia Pty Ltd), Sylgard 408 (Dow Corning Australia Pty Ltd), Sylwet L-77 (GE Silicones), and Sylwet 408 (GE Silicones). The molecular formula of 3-(3-hydroxypropyl)-heptamethyltrisiloxane, ethoxylated, acetate is (C₂H₄O)ₙC₁₂H₃₀O₄Si₃, wherein n is an integer from 1 to 100, preferably from 1 to 50, more preferably from 1 to 15, most preferably from 3 to 10.

The inventor of the present invention has surprisingly found that the formulation of the present invention spreads more effectively over the skin of an animal than similar formulations not containing about 20 g/L or more of organo-silicone surfactant.

The spreading, wetting and infiltration properties of the formulation contributes to the efficacy of the formulation in preventing and controlling ectoparasites on an animal.

To minimise handling of an animal, it is preferable to be able to topically apply a parasiticidal formulation to the back of the animal or other localised portion of the skin or fleece of the animal, rather than apply the formulation to the entire body of the animal.

However, ectoparasites on an animal are typically more prevalent in the rear, crutch or underside of the animal. For example, fly strike on sheep is typically most severe at the rear and crutch of the animal. The ability of a parasiticidal formulation to move through the hair, wool or fleece of an animal to control ectoparasites over the entire body of the animal is a significant factor affecting the efficacy of a parasitical formulation applied by localised topical application (e.g. to the back, or part of the back, of the animal) to control ectoparasites on the animal.

In addition to facilitating the spreading, wetting and penetration of the formulation, the organo-silicone surfactant in the formulation of the present invention may also assist in stabilising the formulation and, for parasiticides that are sparingly soluble in water, may assist in suspending the parasiticide in an aqueous carrier.

The topically acceptable liquid carrier may be any topically acceptable liquid solvent, suspending agent or vehicle for delivering the parasiticide to the animal. The carrier is “topically acceptable” in the sense that the carrier may be topically applied to an animal, along with the parasiticide, without causing any, or a substantial, adverse reaction. The carrier is a liquid at the temperatures used when applying the formulation to an animal.

A person skilled in the art could readily select a topically acceptable liquid carrier for a particular formulation having regard to the stability and solubility of the parasiticide, and the other components of the formulation, in the carrier.

The liquid carrier may be an organic solvent such as acetone, ethyl acetate, acetonitrile, acetyltributyl citrate, benzyl alcohol, butyldiglycol, dimethyl acetate, dimethylacetamide, dimethylformamide, dipropylene glycol n-butyl ether, dipropylene glycol monomethyl ether, 2-ethyl-1-hexanol, ethylene glycol monomethyl ether, liquid polyoxyethylene glycols, propylene glycol, 2-pyrollidone, N-methylpyrrolidone, ethyleneglycol monomethyl ether, diethyleneglycol monomethyl ether, ethylene glycol, diethyl phthalate, fatty acid esters, diisobutyl adipate, ethanol, isopropanol, n-butanol, or methanol, or a combination thereof.

Preferably the topically acceptable liquid carrier is an aqueous carrier. The aqueous carrier may, for example, be water or an aqueous solution. The carrier may comprise water and one or more water-miscible organic solvents. Typically, the formulation comprises about 300 g/L or more of water, e.g. about 500 g/L or more, about 600 g/L or more, 650 g/L or more or 700 g/L or more, of water. Accordingly, in some embodiments, the formulation is an aqueous formulation for topical application to an animal, comprising
(a) a parasiticide;
(b) about 20 g/L or more of organo-silicone surfactant; and
(c) 500 g/L or more of water.

The formulation may contain one or more other surfactants in addition to one or more organo-silicone surfactants. The formulation may, for example, comprise a wetting agent. When the formulation comprises a water insoluble parasiticide suspended in an aqueous carrier, the formulation typically comprises one or more wetting agents to facilitate the wetting of the parasiticide during manufacture of the formulation. The formulation may also comprise one or more additional surfactants to assist in the dispersal of the parasiticide in the formulation or to assist in the spreading of the formulation on the animal when the formulation is topically applied to the animal. The additional surfactant may be a non-ionic, an anionic or a cationic surfactant. Examples of non-ionic surfactants include sorbitan esters, polyoxyalkylated sorbitan esters including polyoxyalkylated sorbitan fatty acid esters, polyoxyalkylated alkyl ethers, polyoxyalkylated fatty alcohols (also known as fatty alcohol alkoxylates), polyoxyalkylated fatty acids, polyalkylene glycol esters, polyoxyalkylated derivatives of castor oil, polyoxyalkylated vegetable oils, polyglycerol esters, copolymers of ethylene oxide and propylene oxide, fatty amine alkoxylates, alkylphenol alkoxylates, alkyl polysaccharides, polymeric surfactants, polydimethylsiloxanes including polyalkyleneoxide modified polydimethylsiloxanes and combinations thereof. Examples of anionic surfactants include linear alkylbenzene sulphonates, alkylnaphthalene sulphonates, C₁₂ to C₁₆ alcohol sulphates, C₁₋₂ alkoxypolyethanoxy sulphates, alkyl phosphates and phosphonates, alkylated alkylphenols, alkylphenol polyalkylate phosphate esters and combinations thereof. Examples of cationic surfactants include benzalkonium, cetyltrimethylammonium chloride, cetyl pyridinium chloride, cetyl trimethylammonium bromide, tonzonium bromide and combinations thereof. In some embodiments, the formulation may comprise a combination of compatible non-ionic, anionic and/or cationic surfactants, e.g. one or more non-ionic surfactants in combination with one or more anionic surfactants.

The additional surfactant or surfactants may, for example, be present in an amount of about 10 g/L to about 450 g/L, about 50 g/L to about 400 g/L or about 200 g/L to about 400 g/L of the total formulation.

In some embodiments, the formulation of the present invention may further comprise one or more agents selected from water-miscible co-solvents, pH modifiers, buffers, preservatives, anti-foam agents, dyes, adjuvants, wetting agents, viscosity modifiers and humectants.

Typically the formulation comprises one or more of a buffer or a preservative to extend the shelf-life of the formulation.

Some parasiticides are more stable at a particular pH. The formulation may therefore comprise one or more buffers or pH adjustors to adjust the pH of the formulation and maintain the pH of the formulation at a pH suitable to extend the shelf-life of the formulation.

The buffer will be selected depending on the particular parasiticide and other ingredients in the formulation and the sensitivity of the parasiticide and other ingredients to different pH. Suitable buffers will generally maintain the pH of the formulation in the range of about 4 to about 8, e.g. 5.5 to 7.5, 6 to 7.5, or 6.5 to 7.5. Suitable buffers include soluble monobasic and/or dibasic phosphates, such as sodium dihydrogen orthophosphate. Alternatively, a buffering system may be used where a combination of two or more buffers and/or pH modifying agents are combined to provide the desired pH range. The buffer may, for example, be present in the formulation in an amount of about 0.2 to about 20 g/L, for example, about 5 to about 10 g/L, based on the total formulation.

Suitable pH modifiers may be used independently or in conjunction with compatible buffers either as a separate additive or as part of a buffering system. Suitable pH modifiers include sodium hydroxide, potassium hydroxide, calcium hydroxide, sodium carbonate, potassium carbonate, ascorbic acid and citric acid.

The preservative may, for example, be an anti-oxidant, anti-microbial, free-radical scavenger or any other agent that extends the shelf-life of the formulation. For example, the preservative may be selected from formaldehyde, diazolidinyl urea, hydroxybenzoate derivatives including sodium methyl hydroxybenzoate and sodium propyl hydroxybenzoate, 1,2-benzisothiazolin-3-one, sodium hydroxymethylglycinate, benzoic acid, sodium benzoate, sodium propionate, sorbic acid, benzyl alcohol, bronopol, chlorbutol, phenoxyethanol, o-phenoxyethanol, chlorhexidine salts, phenylmercuric salts, thiomersal, chlorocresol, cresol, phenol, benzalkonium chloride, cetrimide, alpha-tocopherol, ascorbic acid, sodium ascorbate, butylated hydroxyanisole, butylated hydroxytoluene or sodium metabisulfite, or a combination thereof. A suitable anti-microbial for use in the formulation is 1,2-benzisothiazolin-3-one.

The preservative may, for example, be present in the formulation in an amount of about 0.5 g/L to about 10 g/L based on the total formulation. In some embodiments, the preservative is present in an amount of about 1.0 g/L to about 5 g/L based on the total formulation.

The formulation may comprise one or more anti-foam agents to prevent foaming of the formulation during manufacture of the formulation and during application of the formulation to an animal. Suitable anti-foam agents include, for example, compounded silicone fluid (Anti-Foam A) or Gensil 2030 (Anti-Foam C). The anti-foam agent may be present in the formulation in, for example, about 0.1 g/L to about 5 g/L, e.g., in an amount of about 0.5 g/L to about 2 g/L or about 0.5 g/L to about 1.5 g/L, based on the total formulation.

The formulation typically comprises a colouring agent or dye. Colouring agents enable treated animals to be readily distinguished from untreated animals. The colouring agent may be dissolved, suspended or dispersed in the formulation. The nature of the colouring agent is unimportant and a wide variety of suitable dyes and pigments will be known to a person skilled in the art. The colouring agent may be soluble or insoluble in water. Generally, however, the colouring agent will be biodegradable so as to fade and not permanently mark the skin or fleece, or scourable so that it can be removed from wool during processing. Examples of suitable colouring agents include: Toluidine Red (CI Pigment Red 3), FD&C Brilliant Blue No. 1 (Brilliant Blue FCF, Hexacol Brilliant Blue), Fast Scarlet Pigment 3610 (Dispers Scarlet FK3610), Luconyl Green FK872, Fluoresceine LT, Tartrazine, Carmine Dispersion R1276 and C.I. Food Red (Carmosine, CI-14720).

The formulation may comprise a suspension of the parasiticide. For example, many insect growth regulators are insoluble in water. Accordingly, formulations of the present invention comprising a water insoluble insect growth regulator and an aqueous carrier typically comprise a suspension of the insect growth regulator in the aqueous carrier.

When the formulation comprises a suspension of the parasiticide, the formulation will typically include a thickener to assist in maintaining the parasiticide in suspension. The thickener may be, for example, acacia, agar, alginic acid, aluminium magnesium silicate, aluminium monostearate, bentonite, carbomers, carmellose, carrageenan, cellulose, ceratonia, cetostearyl alcohol, cetyl alcohol, ethylcellulose, gellan gum, xanthan gum, guaraprolose, hydroxypropyl cellulose, hyetellose, hymetellose, hyprolose, hypromellose or hydroxypropyl methylcellulose, methylcellulose, microcrystalline cellulose, polyethylene oxide or polyethylene glycol, polypropylene glycol, polyvinyl acetate, polyvinyl alcohol, povidone, polyvinyl pyrollidine, silicas, stearyl alcohol and tragacanth, or a combination thereof. In some embodiments, the thickener is a polyethylene glycol, such as PEG300, polypropylene glycol, xanthan gum, microcrystalline cellulose, polyvinyl pyrrolidine or hydroxypropyl cellulose, or a combination thereof.

The thickener may, for example, be present in amounts of about 0.5 g/L to about 15 g/L, about 1 g/L to about 10 g/L or about 2 g/L to about 8 g/L based on the total formulation. The formulation may comprise a humectant to retain moisture in the formulation and prevent the formulation from drying out during storage. The humectant may be, for example, calcium saccharate, calcium stearoyl-lactylate, ceratonia, cetostearyl alcohol, diethylene glycol monopalmitostearate, dipropylene glycol, cyclodextrins, ethylenediamine, ethylene glycol monopalmitostearate, gentisic acid ethanolamide, glycerine, glyceryl monostearate, hexylene glycol, maleic acid, monoglyceride citrate, potassium metaphosphate, propylene glycol, sodium stearoyl-lactylate, sorbitol, sucrose esters or trehalose, or a mixture thereof.

The humectant may, for example, be present in the formulation in amounts of about 10 g/L to 100 g/L, about 20 g/L to about 80 g/L, or about 25 g/L to about 75 g/L, based on the total formulation.

In some embodiments, the formulation comprises two or more parasiticides. The formulation may, in some embodiments, comprise one or more other active agents in addition to one or more parasiticides.

The formulation may be topically applied to an animal to control ectoparasites on the animal. The formulation may be applied to the animal by localised topical application.

In a second aspect, the present invention provides a method of preventing or treating ectoparasites on an animal, comprising topically applying to the animal an effective amount of a formulation according to the first aspect of the present invention.

The animal may be any animal. The animal is typically a mammal. The animal may, for example, be a domestic animal such as a sheep, cow, goat, horse, donkey, mule, llama, alpaca or pig, or a zoo animal. The animal may also, for example, be a companion animal such as a cat or dog. In some embodiments, the animal is a sheep or goat, and the ectoparasites are blow fly larvae.

As will be apparent to a person skilled in the art, an effective amount of the formulation will depend on a variety of factors, including the activity of the parasiticide or parasiticides; the concentration of the parasiticide or parasiticides in the formulation; the age, body weight and general health of the animal; and the nature and severity of the particular ectoparasite infestation to be prevented or treated. A person skilled in the art will readily be able to determine an effective amount of the formulation to prevent or treat an ectoparasite infestation based on the activity of the parasiticide in the formulation against the relevant ectoparasite.

In an embodiment of the method of the present invention, the ectoparasites are blow fly larvae. When the parasiticide is dicyclanil, an effective amount of the formulation to prevent or treat fly strike on sheep may, for example, be an amount containing about 20 mg/kg to about 200 mg/kg of dicyclanil relative to the total body weight of the sheep.

The formulation may be applied to all, or substantially all, of the outer surface (the skin or fleece) of the animal. However, more typically, the formulation is topically applied to less than about 50% of the outer surface of the animal, more preferably to less than about 35% of the outer surface of the animal and most preferably to less than about 20% of the outer surface of the animal.

In a preferred embodiment, the formulation is applied to the animal by localised topical application.

In one embodiment, the localised area to which the formulation is applied topically is the area infested with parasites or likely to be infested with parasites. In another embodiment, the formulation is applied in a line or multiple lines, or in a spot, on the animal's back.

In some embodiments, the formulation is topically applied to an animal susceptible to an infestation of ectoparasites to prevent an infestation of ectoparasites on the animal. In some embodiments, the formulation is topically applied to an animal having an infestation of ectoparasites to treat or control the ectoparasite infestation on the animal by eliminating the ectoparasites from the animal, reducing the severity of the ectoparasite infestation on the animal, or retarding the progression or spread of the ectoparasite infestation on the animal.

The formulation of the present invention may be applied to the animal by any technique suitable for topical administration, including a spraying technique, or a pour-on technique. Suitable formulations may be applied in a liquid form or an aerosol form. The aerosol form may use a liquid or a gas as a propellant.

In a third aspect, the present invention provides use of a formulation according to the first aspect in the manufacture of a medicament for the prevention or treatment of an infestation of ectoparasites on an animal.

In a fourth aspect, the present invention provides a formulation comprising a parasiticide, about 20 g/L or more organo-silicone surfactant and a topically acceptable liquid carrier, for use in the prevention or treatment of an ectoparasite infestation on an animal.

In a fifth aspect, the present invention provides a formulation for topical application to an animal, the formulation comprising:
20 to 60 g/L of a parasiticide;
20 to 200 g/L of organo-silicone surfactant; and
water.

In an embodiment, the formulation according to the fifth aspect comprises 80 to 120 g/L of organo-silicone surfactant.

In an embodiment, the formulation according to the fifth aspect further comprises a humectant.

In another embodiment, the formulation according to the fifth aspect further comprises a wetting agent or other surfactant.

In another embodiment, the formulation according to the fifth aspect further comprises a thickener.

In an embodiment, the formulation according to the fifth aspect further comprises at least one of a buffer, an anti-microbial agent, a pH modifier, an anti-foam agent and/or a dye.

An embodiment of a formulation of the present invention is as follows:

| Ingredient | g/L* |
|---|---|
| Parasiticide (e.g. Dicyclanil) | 33.33 |
| Organo-silicone surfactant (e.g. Sylgard 309) | 100.00 |
| Purified Water - Pharmacopeial Grade | qs to 1 L |
| Humectant (e.g. Propylene Glycol) | 75.98 |
| Anti-foam (e.g. Compounded Silicone Fluid (e.g. | 1.50 |
| Antifoam A Compound, Food Grade) or Non-Ionic | |
| Aqueous Emulsion Containing a Polydimethylsiloxane | |
| (e.g. Gensil 2030)) | |
| Colouring agent (e.g. Dispers Scarlet FK 3610) | 0.30 |
| Thickener (e.g. Magnesium Aluminum Silicate (e.g. | 7.58 |
| Veegum Regular) and Xanthan Gum (e.g. Kelzan S)) | |
| Preservative (e.g. 1,2-Benzisothiazolin-3-one | 2.50 |
| (e.g. Proxel GXL)) | |
| pH modifier (e.g. Sodium Hydroxide) | 0.40 |
| Wetting agents and other surfactants (e.g. | 61.00 |
| Polyoxyethylene 20 Sorbitan Monooleate (e.g. | |
| Ecoteric T20); Alkylnapthalene Sulfonate Condensate, | |
| Sodium Salt (e.g. Morwet D425); Nonylphenol, | |
| Ethoxylated Blend (e.g. Teric 200); and Nonylphenol | |
| Polyethoxylate Phosphate Ester (e.g. Gafac RE 610)) | |

Notes:
*Concentrations provided are approximate and are intended to be within +/−10%

The formulation of the present invention may be prepared by any suitable technique. For example, an aqueous formulation comprising a water insoluble parasiticide may be prepared by first preparing a concentrate of the parasiticide, milling the concentrate, mixing the milled concentrate with a water phase, adjusting the pH of the resultant mixture to about 6.5 to about 7.5, and then adding the organo-silicone surfactant. The concentrate may, for example, be prepared by mixing the parasiticide, wetting agent, humectant, colouring agent and water. The water phase may comprise water, thickener, antifoam, preservative, buffer and pH adjuster.

Embodiments of the invention are described below, by way of example only, with reference to the following examples.

### EXAMPLES

### Example 1

### Comparative Example

A formulation comprising 50 g/L dicyclanil and 30 g/L of the surfactant TWEEN 80 was prepared comprising similar excipients in similar amounts to a commercially available topical formulation containing a different parasiticide. The formulation was then tested for efficacy in the control of fly strike. The formulation comprised the components listed below.

| Ingredients | g/L |
|---|---|
| Propylene Glycol | 60.00 |
| Xanthan Gum (Keltrol F) | 4.00 |
| Polyoxyethylene Sorbitan Monooleate (Tween 80) | 30.00 |
| Methyl Paraben | 1.80 |
| Propyl Paraben | 0.20 |
| Citric Acid | 1.80 |
| Disodium Hydrogen Phosphate | 6.65 |
| Dispers Scarlet 3610 | 0.30 |
| Phenol Sulfonic Acid Formaldehyde Concentrate (Tamol PP) | 3.00 |
| Simethicone (Antifoam A) | 0.65 |
| Simethicone (Antifoam C) | 0.35 |
| Dicyclanil | 50.00 |
| Deionised (DI) Water | q.s |

The above formulation was used in an Implant Trial Study to determine its efficacy against fly strike on sheep. In the Implant Trial Study the formulation was topically applied to the back, crutch and rump areas of the sheep at a dose rate of 52.5 mg to 105 mg dicyclanil per kg body weight. The study showed the formulation lacked sufficient efficacy and the study was terminated after 62 days.

Further tests showed that the formulation appeared beady on contact with wool. Various alternative formulations containing different surfactants or liquid lanolin were tested to assess the wetting and spreading properties. Amongst the formulations tested were formulations containing the surfactant Teric BL8, Termul 5030, Teric 200, Teric 169, Span 85 or Sylgard 309 at a concentration of 100 to 150 g/L. The resulting formulations were evaluated by applying 0.5 to 1.0 ml of each formulation to raw wool. The extent of wetting and spreading was observed visually. The formulation containing the organo-silicone surfactant, Sylgard 309, had greater spreading and wetting properties when applied to wool than the formulations containing other surfactants.

### Example 2

### Evaluation of Dicyclanil Formulations Against the Australian Sheep Blowfly Larvae (Lucilia cuprina) Using Larval Implants on Sheep

### Formulation Details

### Investigational Veterinary Product 1 (IVP 1): Formulation Components

| Ingredients | g/L |
|---|---|
| DI Water | 782.35 |
| Xanthan Gum (Keltrol F) | 2.00 |
| Propylene Glycol | 60.00 |
| Polyoxyethylene Sorbitan Monooleate (Tween 80) | 30.00 |
| Methyl Paraben | 1.80 |
| Propyl Paraben | 0.20 |
| Citric Acid | 0.70 |
| Disodium Hydrogen Phosphate | 6.65 |
| Disperse Scarlet 3610 | 0.30 |
| Phenol Sulfonic Acid Formaldehyde Conc. (Tamol PP) | 3.00 |
| Simethicone (Antifoam A) | 0.35 |
| Simethicone (Antifoam C) | 0.65 |
| Dicyclanil (98% Purity) | 35.00 |
| Sylgard 309 | 100.00 |

### Investigational Veterinary Product 2 (IVP 2): Formulation Components

| Ingredients | g/L |
|---|---|
| DI Water | 696.55 |
| Xanthan Gum (Keltrol F) | 2.00 |
| Propylene Glycol | 60.00 |
| Polyoxyethylene Sorbitan Monooleate (Tween 80) | 30.00 |
| Methyl Paraben | 1.80 |
| Propyl Paraben | 0.20 |
| Citric Acid | 1.50 |
| Disodium Hydrogen Phosphate | 6.65 |
| Disperse Scarlet 3610 | 0.30 |
| Phenol Sulfonic Acid Formaldehyde Conc. (Tamol PP) | 3.00 |
| Simethicone (Antifoam A) | 0.35 |
| Simethicone (Antifoam C) | 0.65 |
| Dicyclanil (98% Purity) | 35.00 |
| Solan E 50 (Liquid Lanolin - 50%) | 200.00 |

### Investigational Veterinary Product 3 (IVP 3): Formulation Components

| Ingredients | g/L |
|---|---|
| Disperse Scarlet 3610 | 0.30 |
| Dicyclanil (98% Purity) | 35.00 |
| Sylgard 309 | 100.00 |
| Dimethyl Acetate | 637.58 |
| Teric BL8 | 200.00 |

### Investigational Veterinary Product 4 (IVP 4): Formulation Components

| Ingredients | g/L |
|---|---|
| Dicyclanil (98% Purity) | 35.00 |
| Fluilan (Lanolin) | 200.00 |
| 2-Ethyl-1 Hexanol | 610.41 |
| Lanette 16 (Cetyl Alcohol) | 7.00 |
| Polyoxyethylene (20) Cetyl Ether | 10.00 |
| Butylatedhydroxyanisole | 0.10 |
| Colloidal Silicone Dioxide NF (Wacker HDK N20) | 10.00 |

IVP 1 and IVP 3 contain Sylgard 309. Sylgard 309 is an organo-silicone surfactant. IVP 1 and IVP 2 are aqueous formulations. IVP 3 and IVP 4 are non-aqueous formulations.

The Investigational Veterinary Products were prepared by conventional formulation techniques. In summary, IVP 1 and IVP 2 were prepared by first preparing a concentrate of dicyclanil, milling the concentrate, and then mixing the milled concentrate with a water phase containing the remaining ingredients of the formulation. IVP 3 and IVP 4 were prepared by dissolving the dicyclanil in the organic solvent, and then mixing the resultant solution with the remaining components of the formulation; a further portion of organic solvent was added to obtain the desired concentration of dicyclanil.

### Results and Discussion

One small paddock pen study was conducted over a period of five months. Forty sheep were randomly allocated to five treatment groups following ranking and blocking based on bodyweights. There was one spare sheep in each group. The sheep were group housed according to treatment and did not contact any other sheep during the study period.

The following treatments were evaluated in the study:

| | | | | | Number of |
|---|---|---|---|---|---|
| | | Dicyclanil | | Number of | Sheep |
| | | Concentration | Dose Rate | Sheep | Receiving |
| Treatment Group | | (g/L) | (mg/kg) | Treated | Implant |
| 1. | IVP 1 | 35 | 31.5-110.25 | 8 | 7 |
| | (aqueous | | | | |
| | Sylgard) | | | | |
| 2. | IVP 2 | 35 | 31.5-110.25 | 8 | 7 |
| | (aqueous | | | | |
| | Lanoline) | | | | |
| 3. | IVP 3 | 35 | 31.5-110.25 | 8 | 7 |
| | (solvent | | | | |
| | Dmac) | | | | |
| 4. | IVP 4 | 35 | 31.5-110.25 | 8 | 7 |
| | (oil | | | | |
| | suspension) | | | | |
| 5. | Negative | N/A | N/A | 8 | 7 |
| | Control | | | | |

On Day-1, all sheep were tagged, weighed and allocated. On Day 0, groups were treated with the appropriate treatments. In each of Groups 1 to 4, the formulation was topically applied to the back, crutch and rump areas of the sheep. Group 5 remained untreated.

After treatment, at 4, 8, 12, 16, 20 and 24 weeks after treatment (WAT), each sheep was implanted with first instar larvae of the laboratory bred strain of Australian sheep blowfly (Lucilia cuprina) and assessments were made at 24, 48 and 72 hours post-implant to assess the efficacy of the treatment in controlling larval populations and inhibiting larval growth and development.

Assessments included: number of larvae present, size of larvae, strike size and larvae appearance. Larvae surviving at 72 hours were removed from the treated sheep and placed into a labelled plastic container and maintained in the laboratory insectary on mutton to determine if they could complete their life cycle. The strikes were then clipped out and treated with sodium tetraborate powder to eliminate the viability of the strike and minimise animal discomfort. Negative control strikes were resolved after the 24 hour assessment.

IVP's 1, 2 and 3 showed consistently higher control of the strikes than IVP 4. IVP 4 (Oil suspension) never controlled all strikes at any time point during the trial and reached a maximum efficacy of 11/14 strikes controlled at 4, 8 and 12 WAT. After that the efficacy declined further to only 3/14 at 24 WAT.

The mean number of strikes controlled at 4 WAT was 14/14 for IVP 1 (Aqueous Sylgard) at 24 hours, IVP 2 (Aqueous Lanoline) reached 14/14 at 48 hours and IVP 3 (Solvent Dmac) was 14/14 at 72 hours post implant.

At 8 WAT the number of strikes controlled at 72 hours was 14/14 for IVP 2 and 13/14 for IVP 3 whilst IVP 1 reached 12/14 strikes controlled.

At 12 WAT, IVP 3 provided 14/14 strikes controlled at 24 hours, and IVP's 1 and 2 had controlled 13/14 of strikes at 72 hours.

At 20 WAT the efficacy of IVP 2 declined sharply to 6/14 at 72 hours and the trend for this group continued at 24 WAT when only 4/14 of the strikes were controlled at 72 hours.

IVP 1 and IVP 3 maintained a higher efficacy level until the end of the study with 10/14 strikes controlled by both IVP 1 and IVP 3 at 20 WAT, and 9/14 and 8/14 strikes controlled at 24 WAT respectively.

All IVP groups with uncontrolled strikes had significantly fewer larvae and smaller strikes than the untreated control group at 24 hours post-implanting.

The best performing formulations were IVP 3 (Solvent Dmac) and IVP 1 (Aqueous Sylgard). Both IVP's showed a high level of efficacy until 16 WAT and the activity remained at moderate level until 24 WAT.

IVP 3 (as well as IVP 4) produced a strong odour at treatment however that was irritating to the eyes and nose. Therefore, IVP 1 was the only formulation that was safe to apply and provided a consistently high level of efficacy.

All larvae collected at 4 and 8 WAT from uncontrolled strikes in Groups 1, 3 and 4 failed to develop into pupae and died.

At 12 WAT larvae collected from Groups 1, 2 and 4 pupated in low numbers with 20% larvae pupating in Group 1 (1 pupa), 100% pupae developed from larvae collected in Group 2 (5 pupae) and 40% pupae formed in Group 4 (12 pupae).

At 16 WAT 12% pupated in Group 1 (3 pupae) and 57% larvae pupated in Group 4 (30 pupae).

The numbers of collected larvae as well as pupae increased at 20 WAT as the efficacy of the treatments declined with 50% of larvae developing into pupae in Group 1 (20 pupae), 49% in Group 2 (27 pupae) and 47% in Group 4 (28 pupae). In Group 3 (Dmac solvent) only 3 larvae were collected and no pupae were formed.

At 24 WAT there were larvae collected in all groups with 71% larvae progressed to pupal stage in Group 1 (27 pupae) and of that 1 adult fly emerged. 71% larvae developed into pupae in Group 2 (71 pupae) and 4 adults emerged. In Group 3, 72% larvae progressed to the pupal stage but no flies emerged. In Group 4, 29% larvae developed into pupae (28 pupae) and, of that, 4 adult flies emerged.

The data suggests that despite the fact the collected larvae appeared unaffected and were allowed to complete their life cycle in an untreated environment, their further development was inhibited as the pupal development was approximately 50% in all groups up to 20 WAT (with the exception of Group 2 in 12 WAT).

### Example 3

### Evaluation of the Activity of Two Experimental Dicyclanil Formulations Against the Australian Sheep Blowfly Larvae (Lucilia cuprina) Using Larval Implants on Sheep

### Formulation Details

### Investigational Veterinary Product 5 (IVP 5): Formulation Components

| Formulation Components | g/L |
|---|---|
| Purified Water | 739.938 |
| Morwet D 425 | 3.00 |
| Propylene Glycol | 75.98 |
| Polyoxyethylene Sorbitan Monooleate (Ecoteric T80) | 30.00 |
| Antifoam A | 0.85 |
| Antifoam C (Gensil 2030) | 0.65 |
| Disperse Scarlet 3610 | 0.30 |
| *Dicyclanil | 33.33 |
| Veegum | 5.80 |
| Kelzan S | 1.78 |
| Teric 200 | 22.4 |
| Gafac RE 610 | 5.60 |
| Formalin 37% | 0.30 |
| Sodium Hydroxide - 10% Solution | 56.0 |
| Sylgard 309 | 100.00 |

*The amount of Dicyclanil was factored according to the purity of the batch used

### Investigational Veterinary Product 6 (IVP 6): Formulation Components

| Formulation Components | g/L |
|---|---|
| Purified Water | 783.52 |
| Acrylates/C10-30 Alkyl Acrylate Crosspolymer (Pemulen TR2) | 2.00 |
| Propylene Glycol | 60.00 |
| Polyoxyethylene Sorbitan Monooleate (Tween 80) | 30.00 |
| 1,2-Benzisothiazolinone 3- one (BIT) (Proxel GXL) | 2.50 |
| Citric Acid | 0.70 |
| Disodium Hydrogen Phosphate | 6.65 |
| Disperse Scarlet 3610 | 0.30 |
| Alkylnaphthalene Sulfonate Condensate, | 3.00 |
| Sodium Salt (Morwet D425) | |
| Simethicone (Antifoam A) | 0.35 |
| Simethicone (Antifoam C) | 0.65 |
| *Dicyclanil | 33.33 |
| Sylgard 309 (Silicone Surfactant - Spreading Agent) | 100.00 |

*The amount of Dicyclanil was factored according to the purity of the batch used

### IVP 5 was Prepared by the Following Steps:

### Part A—Dicyclanil Concentrate

1. Transfer a portion of PURIFIED WATER to the manufacturing vessel.
2. Add with stirring MORWET D-425 and stir until dissolved.
3. Add with stirring a portion of PROPYLENE GLYCOL, ECOTERIC T80 and stir until dissolved, approximately 30 minutes.
4. Add with stirring a portion of ANTIFOAM A COMPOUND FOOD GRADE and GENSIL 2030 and stir until homogeneous.
5. Add with stirring a portion of PROXEL GXL. Continue stirring until homogeneous.
6. Add with stirring TOLUIDINE RED (i.e. DISPERS SCARLET FK 3610) to the manufacturing vessel. Rinse container with a portion of PURIFIED WATER and add to the batch. Continue stirring the batch slowly.
7. Add slowly with stirring the DICYCLANIL and stir for 30 minutes. Leave concentrate to age overnight before milling. Concentrate will turn thick & very dark pink.
Note: When possible keep the batch stirring slowly overnight to avoid any settling and possible caking on the bottom of the tank.
8. Mix the concentrate for 15 minutes prior to milling. Mill Part A through a Dyno Mill containing 1.00-1.25 mm SEPR Zirconium Silicate beads to reduce the particle size of the Dicyclanil to 90% less than 10 μm. Once the required particle size has been achieved continue stirring slowly to prevent settling.
9. Rinse the Dyno Mill with a portion of PURIFIED WATER and add the rinsing to the batch.

### Part B—Water Phase

1. Melt Teric 200 in a hot water bath or oven overnight.
2. In a separate manufacturing vessel to Part A, add the following in sequence: portion of PURIFIED WATER and VEEGUM REGULAR. Stir for 10 minutes to disperse. Start heating to 70-80° C.
3. In a separate mixing vessel, premix a portion of PROPYLENE GLYCOL and KELZAN S. Stir to disperse the Kelzan S particles.
4. When the temperature of the main manufacturing vessel reaches 70-80° C., add the premix with stirring. Rinse the premix vessel with portion of PURIFIED WATER then add rinsings to batch. Continue mixing for 2 hours at 70-80° C. to fully hydrate the gum.
5. In another mixing vessel, premix a portion of PROPYLENE GLYCOL and melted TERIC 200. Mix until homogeneous then transfer to the main manufacturing vessel. Rinse premix vessel with portion of PURIFIED WATER and add to batch. Continue mixing for 5-10 minutes. Start cooling the batch to 40° C.
6. When the temperature of the batch has reached 40° C., add in sequence to the main manufacturing vessel GAFAC RE 610 and portion of PROXEL GXL. Continue stirring for 5 minutes or until homogeneous.
7. Add slowly with stirring Part A DICYCLANIL CONCENTRATE, rinse the manufacturing vessel used for Part A with a portion of PURIFIED WATER and add to the batch, stir for 30 minutes.
8. In another mixing vessel, premix a portion of ANTIFOAM A COMPOUND FOOD GRADE to a portion of PURIFIED WATER. Mix until dissolved then add to main manufacturing vessel. Rinse with portion of PURIFIED WATER. Continue mixing for 10 minutes.
9. Take sample and test for pH. If required adjust pH to a pH range of 6.5-7.5. The pH can be lowered with CITRIC ACID SOLUTION or raised with portion of SODIUM HYDROXIDE Pellets dissolved in a portion of PURIFIED WATER if required. Continue stirring batch.
10. When the pH is correct, slowly add SYLGARD 309 and continue mixing for another 30 minutes.
11. Check the batch weight and volume.
12. Adjust according to planned batch weight and volume if too low (check aeration before any volume adjustment).
13. Transfer with a pump through a 100 micron monofilament GAF filter to a stainless steel holding tank in readiness for filling.
15. Fill into approved containers.

A similar method was used to prepare IVP 6.

### Results and Discussion

One small paddock pen study was conducted over seven months. Twenty seven sheep were randomly allocated to three treatment groups following ranking and blocking based on bodyweights. There was one spare sheep in each group. The sheep were group housed according to treatment and did not contact any other sheep during the study period.

The following treatments were evaluated in the study:

| | | | | Number of |
|---|---|---|---|---|
| | Dicyclanil | | Number of | Sheep |
| | Concentration | Dose Rate | Sheep | Receiving |
| Treatment Group | (g/L) | (mg/kg) | Treated | Implants |
| 1. IVP 5 | 33.33 | 30-105 | 9 | 8 |
| 2. IVP 6 | 33.33 | 30-105 | 9 | 8 |
| 3. Negative Control | NA | NA | 9 | 8 |

On Day 0, all sheep were tagged, weighed and allocated and Group 1 and Group 2 were treated with the appropriate treatments. For each of Groups 1 and 2, the formulation was topically applied to the back, crutch and rump areas of the sheep. Group 3 remained untreated.

At 28, 56, 84, 112, 140 and 168 days after treatment (DAT) each sheep was implanted with first instar larvae of the laboratory bred strain of Australian sheep blowfly (Lucilia cuprina) and assessments were made at 24, 48 and 72 hours post-implant to assess the efficacy of the treatment in controlling larval populations and inhibiting larval growth and development.

Assessments included: number of larvae present, size of larvae, strike size and larvae appearance. Larvae surviving at 72 hours were removed from the treated sheep and placed into a labelled plastic container and maintained in the laboratory insectary on mutton to determine if they could complete their life cycle. The strikes were then clipped out and treated with sodium tetraborate powder to eliminate the viability of the strike and minimise animal discomfort. Negative control strikes were resolved after the 24 hour assessment.

Both Investigational Veterinary Product (IVP) groups showed a significant effect on the strikes 24 hours post-implant until 20 weeks post-treatment (WAT).

The mean number of strikes controlled by both IVPs at 4 WAT was 13/16 at 24 hours, and both reached 16/16 by 72 hours post implant.

At 8 WAT the number of strikes controlled at 24 hours was 16/16 for both IVP 5 and IVP 6.

At 12 WAT, IVP 5 provided 16/16 strikes controlled at 24 hours, IVP 6 had controlled 15/16 of strikes. At 16 WAT IVP 5 and IVP 6 controlled 16/16 strikes by 72 hours post implant. At 20 WAT the efficacy of the IVPs declined to 13/16 at 72 hours.

The decline in efficacy continued at 24 WAT when for IVP 5 5/16 of strikes and for IVP 6 3/16 of the strikes were controlled at 72 hours.

Both IVP groups with uncontrolled strikes had significantly fewer larvae and smaller strikes than the untreated control group at 24 hours post-implanting.

There was no statistically significant difference between the efficacies in the treated groups at 72 hours at any time point during the trial. IVP 5 as well as IVP 6 showed a high level of efficacy until 16 WAT and the activity remained at moderate level until 20 WAT.

Where strikes were not completely controlled, IVP 5 and IVP 6 treatments demonstrated efficacy by restricting the size of the strikes and the number of larvae.

Low numbers of larvae were collected at 4 and 12 WAT from uncontrolled strikes in Groups 1 and 2 and allowed to complete their life cycle on untreated mutton in the insectary. None of the larvae developed into pupal or adult stages.

The numbers of collected larvae as well as pupae increased at 20 WAT as the efficacy of the treatments declined with 36% (9) of larvae developing into pupae in Group 1 and 93% (28) in Group 2. However zero pupae developed into adult flies in any of the treatment groups.

At 24 WAT there were considerable numbers of larvae collected in all groups. In Group 1, 70% (71) larvae developed into pupae and 5% (5) adult flies emerged. In Group 2, 76% (93) larvae developed into pupae and 20% (25) adults emerged.

The data suggests that despite the fact the collected larvae appeared mostly unaffected and were allowed to complete their life cycle in an untreated environment their further development was generally inhibited as the pupal emergence of adult flies was low.

### Example 4

### Evaluation of the Efficacy of a Dicyclanil Spray-on Formulation as a Preventative Treatment Against Fly Strike in Sheep Caused by Field Strains of Various Australian Blowflies

### Formulation Details

Investigational Veterinary Product 7 (IVP 7): Formulation Components

| Formulation Components | g/L |
|---|---|
| Purified Water | qs to 1 L |
| Morwet D 425 | 3.0 |
| Propylene Glycol | 75.98 |
| Polyoxyethylene Sorbitan Monooleate (Ecoteric T80) | 30 |
| Antifoam A | 0.85 |
| Antifoam C (Gensil 2030) | 0.65 |
| Disperse Scarlet 3610 | 0.30 |
| * Dicyclanil | 33.33 |
| Veegum | 5.8 |
| Kelzan S | 1.78 |
| Teric 200 | 22.4 |
| Gafac RE 610 | 5.6 |
| Formalin 37% | 0.30 |
| Sodium Hydroxide - 10% Solution | 0.40 |
| Sylgard 309 | 100 |

Note:
* Adjust amount of Dicyclanil based on purity of active material.

IVP 7 was prepared by a process similar to that described for IVP 5 in Example 3.

### Results and Discussion

Ten field studies were conducted over 9 months to evaluate the efficacy of IVP 7 as a preventative treatment against fly strike in sheep caused by field strains of various Australian blowflies. The studies were conducted in New South Wales, Victoria, South Australia and Western Australia on properties known to have been affected by fly strike in the past.

Ten sheep were weighed and treatment rates were based on the weight of the heaviest sheep from the two groups combined. Wool length was also measured on the 10 sheep at the shoulder, mid-back and hip regions prior to treatment. The formulation was applied with a treatment volume of 54 or 45 mL (30-105 mg/kg body weight) of the formulation was applied to the sheep by pour-on applicator (Simcro, NZ) with a spray on nozzle held 15-25 cm above the animal so as to deliver a 15 cm wide band. The formulation was applied in two bands along the back of the animal overlapping along the mid-line, and a third band on the crutch and rump areas of the animal.

The sheep at 9 sites were treated over a 3 week period. One site was a late entry into the study. The sheep were inspected for fly strike by the cooperating graziers on a regular basis. The sheep were inspected more often during favourable fly conditions. The Investigators visited the trial sites monthly to inspect the sheep for fly strike with the graziers and assess the skin and fleece reactions. Sheep blowfly surveys were also conducted at these times on the trial properties and neighbouring farms to provide information on fly pressure in the area. Daily minimum and maximum temperatures and humidity were recorded by data loggers placed in the paddocks with the sheep. Rainfall and wind speed greater than 30 km/hr were also recorded daily by the cooperating graziers.

The results from this study showed that only low numbers of sheep were struck in the IVP 7 group (7 animals) at any time during the field trial. Seven of the ten sites had no strikes recorded whilst two sites had three or less strikes recorded. At one site there were 4 strikes recorded in the IVP 7 group. This property experienced a period of wet weather followed by a fly wave accompanied with the sheep scouring and becoming very daggy. As a result 4 sheep in the IVP 7 group became fly struck in the crutch area on this study site.

Daggy wool on the treated animals compromises the efficacy of any preventative external treatment as the first instar larvae are able to survive in the dag only, protected from the treated wool and progress through the life cycle without being sufficiently exposed to the treatment immediately after hatching.

Fly strikes recorded in other mobs on the trial properties and in neighbouring properties indicated that there was sufficient fly pressure to test the efficacy of the IVP 7 product throughout the study period.

At 4 study sites the humid weather accompanied with the incidence of fly strikes in other mobs on the study sites and neighbouring properties arrived late in the study at approximately 5 months post treatments. Even under this fly pressure late in the study IVP 7 showed a satisfactory level of persistent protection from fly strike.

The results from this study showed that IVP 7 provided a high level of protection from fly strike on nine properties out of the total ten.

IVP 7 provided protection from field strains of the Australian blowflies for 24 weeks post treatment under favourable conditions for fly strike.

It was noted by the Investigators that IVP 7 was visible on the sheep for a longer period of time after the treatment application than any other commercially available formulation thus making it easier to distinguish sheep that had been treated from untreated animals.

There were no adverse skin or any other reactions or signs of wool damage recorded during the study.

It is to be understood that a reference herein to a prior art document does not constitute an admission that the document forms part of the common general knowledge in the art in Australia or in any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A formulation for topical application to an animal, the formulation comprising a parasiticide, about 20 g/L or more of organo-silicone surfactant, and a topically acceptable liquid carrier.

2. The formulation of claim 1, wherein the formulation comprises about 20 g/L to about 200 g/L of organo-silicone surfactant.

3. The formulation of claim 1, wherein the formulation comprises about 50 g/L to about 170 g/L of organo-silicone surfactant.

4. The formulation of claim 1, wherein the organo-silicone surfactant is selected from the group consisting of 2-[acetoxy(polyethyleneoxy)propyl]heptamethyltrisiloxane, polyalkylene modified heptamethyltrisiloxane, polydiorganosiloxanes and combinations thereof.

5. The formulation of claim 1, wherein the organo-silicone surfactant is a compound of formula (I): 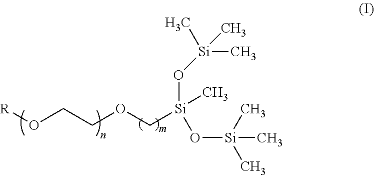
wherein R is selected from hydrogen, optionally substituted C₁-C₆-alkyl, optionally substituted C₂-C₆-alkenyl and optionally substituted C₂-C₇-acetyl;
n is an integer from 1 to 100; and
m is an integer from 1 to 10.

6. The formulation of claim 1, wherein the parasiticide is an insect growth regulator.

7. The formulation of claim 1, wherein the parasiticide is selected from the group consisting of dicyclanil, diflubenzuron, triflumuron, fluazuron, methoprene and combinations thereof.

8. The formulation of claim 1, wherein the parasiticide is dicyclanil.

9. The formulation of claim 1, wherein the parasiticide is present at a concentration of from about 20 g/L to about 60 g/L.

10. The formulation of claim 1, comprising an aqueous carrier.

11. The formulation of claim 1, further comprising one or more agents selected from buffers, anti-microbial agents, preservatives, anti-foam agents, dyes, adjuvants, wetting agents, viscosity modifiers and humectants.

12. The formulation of claim 1, wherein the parasiticide is in suspension in an aqueous carrier.

13. A method of preventing or treating ectoparasites on an animal, the method comprising topically applying to the animal an effective amount of a formulation comprising a parasiticide, about 20 g/L or more of organo-silicone surfactant, and a topically acceptable liquid carrier.

14. The method of claim 13, wherein the ectoparasites are flies.

15. The method of claim 13, wherein the animal is a sheep.

16. The method of claim 13, comprising localised topical application of the formulation.

17. The method of claim 13, wherein the parasiticide is selected from the group consisting of dicyclanil, diflubenzuron, triflumuron, fluazuron, methoprene and combinations thereof.

18. The method of claim 17, wherein the parasiticide is dicyclanil.

19. The method of claim 13, wherein the organo-silicone surfactant is 2-[acetoxy(polyethyleneoxy)propyl]heptamethyltrisiloxane, polyalkylene modified heptamethyltrisiloxane, polydiorganosiloxanes and combinations thereof.

20. The method of claim 13, wherein the formulation comprises about 20 g/L to about 200 g/L of organo-silicone surfactant.
